(19) United States
(12) Patent Application Publication
(10) Pub. No.: US 2009/0103118 A1
(43) Pub. Date: Apr. 23, 2009

(54) COLOR CONVERSION APPARATUS

(75) Inventor: Takayuki Sawada, Numazu-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/876,169

(22) Filed: Oct. 22, 2007

(51) Int. Cl. G06K 1/00

(52) U.S. Cl. 358/1.9

(57) ABSTRACT

A determination unit of a color conversion apparatus refers to Pure Gray allowance designation information supplied from outside. In a case where the Pure Gray allowance designation information is forcible Enable to unconditionally allow Pure Gray, the Pure Gray is determined to be Enable. In a case of forcible Disable to unconditionally inhibit, the Pure Gray is determined to be Disable. In a case of automatic selection to automatically determine Enable or Disable based on color distribution information, a determination is made based on the color distribution information as to whether an achromatic color is included in the color arrangement or color arrangement pattern of a drawing object under attention, whether the color arrangement is uniform, and whether a chromatic color is included in the color arrangement pattern.

### BACKGROUND OF THE INVENTION

1. Field of the Invention

The present invention relates to a color conversion apparatus to perform a color conversion in printing of a color graphic object.

2. Description of the Related Art

Hitherto, in an image processing (mainly a color conversion) of a color printer, in order to suppress unnecessary coloring of an achromatic color, reduction in image quality due to plate shifting, and waste of color toner, a Pure Black/Pure Gray processing (hereinafter simply referred to as Pure Gray including the meaning of Pure Black) for performing image formation with only a black color material is performed on a drawing object of an achromatic color or a low saturation color.

However, since the Pure Gray disturbs smooth and natural tone reproduction, the Pure Gray is managed by switching Enable/Disable of the Pure Gray according to the kind of a drawing object such as a text, an image, a line drawing, and a figure (plane figure). Specifically, it is generally appropriate that Enable is selected for the text or the line drawing in which importance is given to understandability or viewability, and Disable is selected for the image in which fine and natural reproduction is requested.

However, with respect to the plane figure, the Pure Gray does not always function effectively, and on the contrary, there is also a case where the image quality is degraded. For example, in gradation between an achromatic color and a chromatic color, a pseudo-contour is liable to occur at a boundary between low saturation and high saturation, and smooth tone reproduction is impaired. Thus, the way of unconditionally designating Enable/Disable for the plane figure has been unsuitable in balancing the object of the Pure Gray (to suppress the unnecessary coloring of an achromatic color, the reduction in image quality due to plate shift, and the waste of color toner) with the smooth tone reproduction. Besides, also with respect to the image, since there is also a case where it is preferable to select Enable as in a black and white photograph, it is unsuitable to unconditionally designate Enable/Disable.

### BRIEF SUMMARY OF THE INVENTION

The present invention has an object to provide a color conversion apparatus which can enjoy merits of Pure Gray without impairing smooth tone reproduction when the whole document image is seen.

According to an aspect of the present invention, there is provided a color conversion apparatus having a Pure Gray function to output, for input of an achromatic color, a color conversion result in which respective data of CMY are zero to reproduce the achromatic color by only a black color material, and the color conversion apparatus includes a Pure Gray allowance and inhibition determining unit that discriminates, based on a state of a color distribution, whether each drawing object appearing on a print document is a drawing object in which an achromatic color and a chromatic color are mixed and arranged or a drawing object in which only an achromatic color is arranged, inhibits the Pure Gray function for the drawing object in which the achromatic color and the chromatic color are mixed and arranged, and allows the Pure Gray function for the drawing object in which only the achromatic color is arranged, and a color conversion unit that executes, based on the determination of allowance or inhibition of the Pure Gray function of the Pure Gray allowance and inhibition determining unit, a color conversion with the Pure Gray function for the allowed drawing object, and executes the color conversion without the Pure Gray function for the inhibited drawing object.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate preferred embodiments of the invention, and together with the general description given above and the detailed description of the embodiments given below, serve to explain the principle of an aspect of the invention.

FIG. 1 is a block diagram showing a schematic structure of a color conversion apparatus of the invention;

FIG. 2A is a view for explaining a harmful effect at the time when Pure Gray is performed on a drawing object having a gradation between an achromatic color and a chromatic color;

FIG. 2B is a view for explaining the harmful effect at the time when the Pure Gray is performed on the drawing object having the gradation between the achromatic color and the chromatic color;

FIG. 3 is a flowchart for explaining an operation of Enable/Disable determination of Pure Gray;

FIG. 4 is a flowchart for explaining an operation of Enable/Disable determination of Pure Gray; and

FIG. 5 is a flowchart for explaining an operation of ON/OFF switching of Pure Gray.

### DETAILED DESCRIPTION OF THE INVENTION

Hereinafter, an embodiment of the present invention will be described with reference to the drawings.

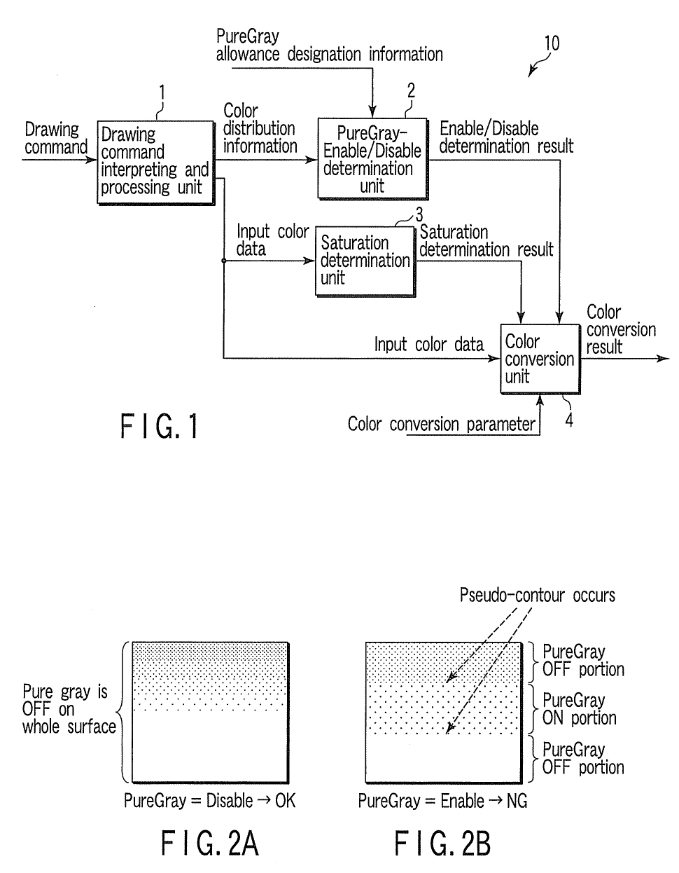

FIG. 1 shows a structure of a color conversion apparatus 10 of the invention. The color conversion apparatus 10 includes a drawing command interpreting and processing unit 1, a Pure Gray-Enable/Disable determination unit 2, a saturation determination unit 3, and a color conversion unit 4.

The drawing command interpreting and processing unit 1 interprets a drawing command supplied from a not-shown printer driver, acquires a state of a color distribution as to which color is arranged in which pattern on a drawing object, and supplies and outputs the result as color distribution information to the Pure Gray-Enable/Disable determination unit 2. The drawing command interpreting and processing unit 1 sequentially outputs all color data constituting the drawing object and supplies them to the saturation determination unit 3 and the color conversion unit 4.

The Pure Gray-Enable/Disable determination unit 2 determines, for each drawing object, whether an after-mentioned Pure Gray processing is allowed (Enable) or inhibited (Disable) based on the color distribution information supplied from the drawing command interpreting and processing unit 1 and Pure Gray allowance designation information inputted from outside, and supplies and outputs the result as an Enable/Disable determination result to the color conversion unit 4.

The saturation determination unit 3 evaluates the saturation on each color data supplied from the drawing command interpreting and processing unit 1 to determine whether it is an achromatic color or a chromatic color, and supplies and outputs the result as a saturation determination result to the color conversion unit 4. Here, the achromatic color is a color whose saturation is lower than a specified threshold, and the chromatic color is a color whose saturation is not lower than the threshold.

The color conversion unit 4 sequentially executes the color conversion on the input color data supplied from the drawing command interpreting and processing unit 1 in accordance with a given color conversion parameter. In the color conversion, the input color data represented in the color space of RGB or the like is converted into CMYK data for printer output.

In the case where a specified condition based on the Enable/Disable determination result supplied from the Pure Gray-Enable/Disable determination unit 2 and the saturation determination result supplied from the saturation determination unit 3 is satisfied, the color conversion unit 4 outputs the color conversion result in which each data of CMY is zero for achromatic color input, so that the reproduction is performed by only a K (black) color material.

The color conversion as stated above is called Pure Gray (or “color conversion with Pure Gray”). Although a case where black in the achromatic color is outputted is sometimes especially called Pure Black and is differentiated, in this embodiment, it is not differentiated and the color conversion is collectively called the Pure Gray.

FIGS. 2A and 2B show an example of a drawing object having a gradation between an achromatic color and a chromatic color, and in the gradation between the achromatic color and the chromatic color, a pseudo-contour is liable to occur at a boundary between low saturation and high saturation, and smooth tone reproduction is impaired.

The invention provides the color conversion apparatus in which the smooth tone reproduction is not impaired.

Next, the operation of the invention will be described by use of a flowchart.

Essential operations of the invention are an operation to determine Enable/Disable of Pure Gray for each drawing object, and an operation to perform a color conversion while switching, based on the determination, whether the Pure Gray is performed or not (ON/OFF) for each input color (each color of each pixel in a case where the drawing object is a bitmap).

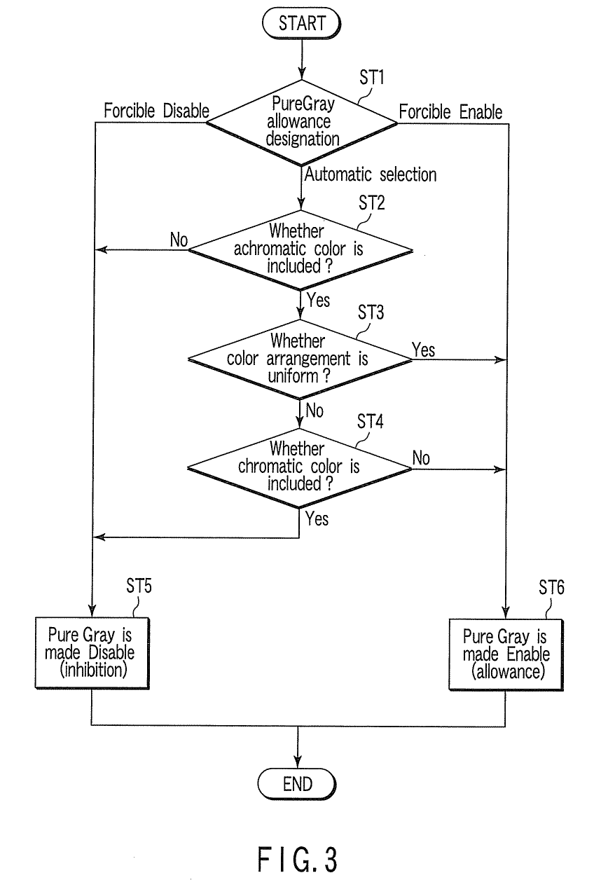

Next, the operation of determining Enable/Disable of the Pure Gray processing in the structure as stated above will be described with reference to a flowchart of FIG. 3.

First, the Pure Gray-Enable/Disable determination unit 2 of the color conversion apparatus 10 refers to Pure Gray allowance designation information supplied from outside. The Pure Gray allowance designation information is information to discriminate three states, that is, forcible Enable to allow the Pure Gray unconditionally, forcible Disable to inhibit it unconditionally, and automatic selection to automatically determine Enable or Disable based on the color distribution information.

In the case (ST1) of the forcible Enable, the Pure Gray is determined to be Enable (ST6). In the case of the forcible Disable (ST1), the Pure Gray is determined to be Disable (ST5). In the case of the automatic selection (ST1), a determination is made based on the color distribution information as to whether an achromatic color is included in the color arrangement or color arrangement pattern of a drawing object under attention (ST2). As a result, in the case where the achromatic color is not included (ST2), it is determined to be Disable (ST5). On the other hand, in the case where the achromatic color is included (ST2), a determination is further made based on the color distribution information as to whether the color arrangement is uniform (ST3). As a result, in the case where the color arrangement is uniform (ST3), it is determined to be Enable (ST6). On the other hand, in the case where the color arrangement is not uniform (ST3), a determination is further made based on the color distribution information as to whether the chromatic color is included in the color arrangement pattern (ST4). As a result, in the case where the chromatic color is not included (ST4), it is determined to be Enable (ST6). On the other hand, in the case where the chromatic color is included (ST4), it is determined to be Disable (ST5).

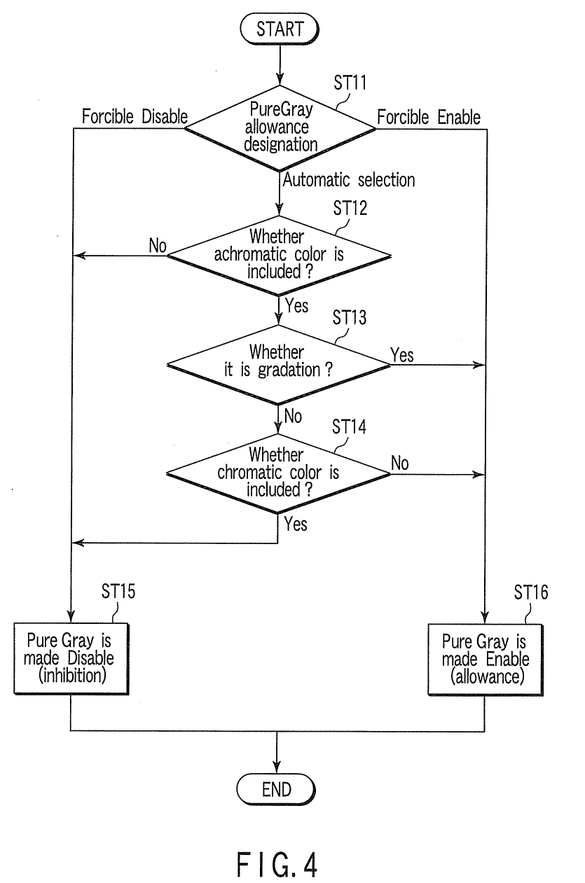

Next, a different method of determining Enable/Disable of the Pure Gray processing from FIG. 3 will be described with reference to a flowchart of FIG. 4.

First, the Pure Gray-Enable/Disable determination unit 2 of the color conversion apparatus 10 refers to Pure Gray allowance designation information supplied from outside. The Pure Gray allowance designation information is information to discriminate three states, that is, forcible Enable to allow the Pure Gray unconditionally, forcible Disable to inhibit it unconditionally, and automatic selection to automatically determine Enable or Disable based on the color distribution information.

In the case of the forcible Enable (ST11), the Pure Gray is determined to be Enable (ST16). In the case of the forcible Disable (ST11), the Pure Gray is determined to be Disable (ST15). In the case of the automatic selection (ST11), a determination is made based on the color distribution information as to whether an achromatic color is included in the color arrangement or color arrangement pattern of a drawing object under attention (ST12). As a result, in the case where the achromatic color is not included (ST12), it is determined to be Disable (ST15). On the other hand, in the case where the achromatic color is included (ST12), a determination is further made based on the color distribution information as to whether the color arrangement is a gradation (ST13). As a result, in the case where the color arrangement is not the gradation (ST13), it is determined to be Enable (ST16). On the other hand, in the case of the gradation (ST13), a determination is further made based on the color distribution information as to whether a chromatic color is included in the color arrangement pattern (ST14). As a result, in the case where the chromatic color is not included (ST14), it is determined to be Enable (ST16). On the other hand, in the case where the chromatic color is included (ST14), it is determined to be Disable (ST15).

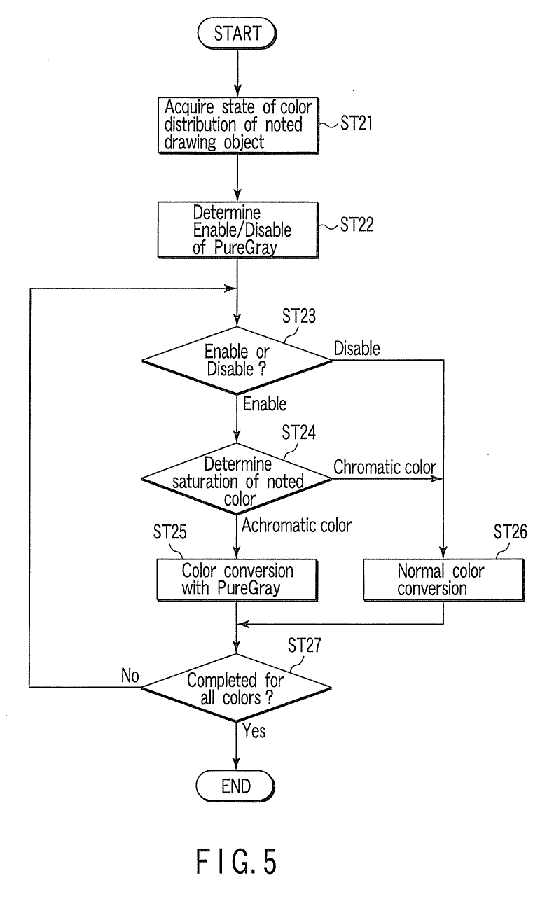

Next, the operation of performing the color conversion while switching ON/OFF of the Pure Gray processing will be described with reference to a flowchart of FIG. 5.

First, in the drawing command interpreting and processing unit 1 of the color conversion apparatus 10, a state (color distribution information) of a color distribution of a drawing object under attention is acquired (ST21). Subsequently, in accordance with the flowchart of FIG. 3, the Enable/Disable of the Pure Gray for the noted drawing object is determined based on the Pure Gray allowance designation information and the color distribution information (ST22).

Until here, the execution is made only once for each drawing object. After this, for the respective colors appearing on the color arrangement of the noted drawing object, the execution is repeated the number of times which corresponds to the number of the colors (or the number of pixels).

First, based on the determination of Enable/Disable, in the case of the Disable (ST23), a normal color conversion (color conversion without the Pure Gray) is executed (ST26). On the other hand, in the case of the Enable (ST23), the saturation of the color under attention is determined by the saturation determination unit 3 (ST24). As a result, when it is a chromatic color, the normal color conversion is executed (ST26). On the other hand, when it is an achromatic color, the color conversion with the Pure Gray is executed (ST25).

In the case where the processing is completed for all colors (ST27), the process is ended.

As described above, according to the embodiment of the invention, the allowance designation of the Pure Gray is set to “automatic selection” for a drawing object such as a figure or an image, so that the Pure Gray is selected and executed only for the drawing object of the uniform achromatic color or the drawing object of the color arrangement pattern (gradation, etc.) formed of only the achromatic color.

On the other hand, for the drawing object of the color arrangement pattern in which the achromatic color and the chromatic color are mixed, the Pure Gray is inhibited, and only the normal color conversion is selected and is executed (the case of FIG. 3). For example, in the example shown in FIGS. 2A and 2B, Pure Gray=Disable of FIG. 2A is selected and the pseudo-contour as in FIG. 2B is avoided.

Besides, in the different implementation method of the invention (the case of FIG. 4), for a drawing object in which colors are arranged in a gradation between an achromatic color and a chromatic color, the Pure Gray is inhibited and only the normal color conversion is selected and is executed. On the other hand, for the other drawing object, the Pure Gray is allowed, and the Pure Gray is executed for the input of the achromatic color.

As stated above, in the output of the printer, the Pure Gray is automatically selected for the object in which the merit of the Pure Gray is remarkable, and the Pure Gray is automatically avoided for the object in which the demerit of the Pure Gray is remarkable, and therefore, when the whole document image is seen, the merit of the Pure Gray (to suppress the unnecessary coloring of an achromatic color, the reduction in image quality due to plate shifting, and the waste of color toner) can be enjoyed without impairing the smooth tone reproduction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A color conversion apparatus having a Pure Gray function to output, for input of an achromatic color, a color conversion result in which respective data of CMY are zero to reproduce the achromatic color by only a black color material, the color conversion apparatus comprising:
a Pure Gray allowance and inhibition determining unit that discriminates, based on a state of a color distribution, whether each drawing object appearing on a print document is a drawing object in which an achromatic color and a chromatic color are mixed and arranged or a drawing object in which only an achromatic color is arranged, inhibits the Pure Gray function for the drawing object in which the achromatic color and the chromatic color are mixed and arranged, and allows the Pure Gray function for the drawing object in which only the achromatic color is arranged; and
a color conversion unit that executes, based on the determination of allowance or inhibition of the Pure Gray function of the Pure Gray allowance and inhibition determining unit, a color conversion with the Pure Gray function for the allowed drawing object, and executes the color conversion without the Pure Gray function for the inhibited drawing object.

2. A color conversion apparatus having a Pure Gray function to output, for input of an achromatic color, a color conversion result in which respective data of CMY are zero to reproduce the achromatic color by only a black color material, the color conversion apparatus comprising:
a Pure Gray allowance and inhibition determining unit that discriminates, based on a state of a color distribution, whether each drawing object appearing on a print document is a drawing object in which colors are arranged in a gradation between an achromatic color and a chromatic color, or a drawing object other than that, inhibits the Pure Gray function for the drawing object in which the colors are arranged in the gradation between the achromatic color and the chromatic color, and allows the Pure Gray function for the drawing object other than that; and
a color conversion unit that executes, based on the determination of allowance or inhibition of the Pure Gray function of the Pure Gray allowance and inhibition determining unit, a color conversion with the Pure Gray function for the allowed drawing object, and executes the color conversion without the Pure Gray function for the inhibited drawing object.

3. A color conversion apparatus having a Pure Gray function to output, for input of an achromatic color, a color conversion result in which respective data of CMY are zero to reproduce the achromatic color by only a black color material, the color conversion apparatus comprising:
a color distribution information supply unit that acquires, for each drawing object appearing on a print document, a state of a color distribution based on a drawing command and outputs the acquired color distribution information;
a Pure Gray allowance and inhibition determining unit that discriminates, based on the color distribution information from the color distribution information supply unit, whether each drawing object is a drawing object in which an achromatic color and a chromatic color are mixed and arranged or a drawing object in which only an achromatic color is arranged, inhibits the Pure Gray function for the drawing object in which the achromatic color and the chromatic color are mixed and arranged, and allows the Pure Gray function for the drawing object in which only the achromatic color is arranged; and
a color conversion unit that executes, based on the determination of allowance or inhibition of the Pure Gray function of the Pure Gray allowance and inhibition determining unit, a color conversion with the Pure Gray function for the allowed drawing object, and executes the color conversion without the Pure Gray function for the inhibited drawing object.

4. A color conversion apparatus having a Pure Gray function to output, for input of an achromatic color, a color conversion result in which respective data of CMY are zero to reproduce the achromatic color by only a black color material, the color conversion apparatus comprising:
a color distribution information supply unit that acquires, for each drawing object appearing on a print document, a state of a color distribution based on a drawing command and outputs the acquired color distribution information;
a Pure Gray allowance and inhibition determining unit that discriminates, based on the color distribution information from the color distribution information supply unit, whether each drawing object is a drawing object in which colors are arranged in a gradation between an achromatic color and a chromatic color, or a drawing object other than that, inhibits the Pure Gray function for the drawing object in which the colors are arranged in the gradation between the achromatic color and the chromatic color, and allows the Pure Gray function for the drawing object other than that; and
a color conversion unit that executes, based on the determination of allowance or inhibition of the Pure Gray function of the Pure Gray allowance and inhibition determining unit, a color conversion with the Pure Gray function for the allowed drawing object, and executes the color conversion without the Pure Gray function for the inhibited drawing object.
